(19) United States
(12) Patent Application Publication
(10) Pub. No.: US 2026/0167263 A1
(43) Pub. Date: Jun. 18, 2026

(54) METHODS AND APPARATUS FOR SHARED STEERING CONTROL FOR VEHICLES

(71) Applicant: Ford Global Technologies, LLC, Dearborn, MI (US)

(72) Inventors: Akshay Bhardwaj, Detroit, MI (US); Ashrit Das, Canton, MI (US); Jens Dornhege, Pulheim (DE); Goetz-Philipp Wegner, Dortmund (DE); Yijun Li, Dearborn, MI (US); Lodewijk Wijffels, Northville, MI (US)

(21) Appl. No.: 18/980,934

(22) Filed: Dec. 13, 2024

(51) Int. Cl. B62D 6/00

(52) U.S. Cl. CPC B62D 6/00

(57) ABSTRACT

Methods and apparatus for shared steering control for vehicles are disclosed herein. An example vehicle includes a user interface, an driver-assistance system to generate a first reference navigation angle and a controller to determine an angle overlay based on an input to the user interface, determine an angle overlay limit based on a driver activity and a speed of the vehicle, modify the angle overlay based on the angle overlay limit to generate a modified angle overlay, determine a second reference navigation angle based on the modified angle overlay and the first reference navigation angle, and control the vehicle based on the second reference navigation angle. Some examples disclosed herein deactivate the driver-assistance system when the limit is exceeded.

### FIELD OF THE DISCLOSURE

This disclosure relates generally to vehicle control and, more particularly, to methods and apparatus for shared steering control for vehicles.

### BACKGROUND

In recent years, some vehicles have been outfitted with advanced driver-assistance systems (ADAS) that can assist a driver in the operation of a vehicle. Some ADAS are path follower systems that analyze the road around the vehicle and a target navigation path for the vehicle based on the analysis. Based on the determined navigation, a steering motor can apply torque to a steering system of the vehicle, which causes the vehicle to navigate along the determined path.

### SUMMARY

An example vehicle disclosed herein includes a user interface, an ADAS to generate a first reference navigation angle and a controller to determine an angle overlay based on an input to the user interface, determine an angle overlay limit based on a driver activity and a speed of the vehicle, modify the angle overlay based on the angle overlay limit to generate a modified angle overlay, determine a second reference navigation angle based on the modified angle overlay and the first reference navigation angle, and control the vehicle based on the second reference navigation angle.

Disclosed herein is a non-transitory computer readable medium comprising instructions, which, when executed cause a processor to determine an angle overlay based on an input to a user interface, determine an angle overlay limit based on a driver activity and a speed of the vehicle, modify the angle overlay based on the angle overlay limit to generate a modified angle overlay, determine a second reference navigation angle based on the modified angle overlay and a first reference navigation angle of an ADAS, and control the vehicle based on the second reference navigation angle.

An example method disclosed herein determining an angle overlay based on an input to a user interface, determining an angle overlay limit based on a driver activity and a speed of the vehicle, modifying the angle overlay based on the angle overlay limit to generate a modified angle overlay, determining a second reference navigation angle based on the modified angle overlay and a first reference navigation angle of an ADAS, and controlling the vehicle based on the second reference navigation angle.

### BRIEF DESCRIPTION OF THE DRAWINGS

FIG. 1 illustrates an example vehicle implemented in accordance with teachings of this disclosure.

FIG. 2 is a schematic diagram of an example steering system of the vehicle of FIG. 1.

FIG. 3 is a block diagram of the example steering controller of FIGS. 1 and 2.

FIG. 4 is a schematic system diagram of a shared-control driving system including a limiter implemented in accordance with teachings of this disclosure.

FIG. 5 is a schematic system diagram of the limiter of FIG. 4.

FIG. 6A is a chart depicting an example first relationship curve between a torque and a driver activity metric.

FIG. 6B is a chart depicting an example second relationship curve between a vehicle speed, a driver activity metric, and a magnitude limit.

FIG. 6C is a chart depicting an example third relationship curve between a vehicle speed, a driver activity metric, and a rate limit.

FIG. 7 is a flowchart representative of example machine readable instructions and/or example operations that may be executed, instantiated, and/or performed by example programmable circuitry to implement the steering controller of FIG. 3.

FIG. 8 is a block diagram of an example processing platform including programmable circuitry structured to execute, instantiate, and/or perform the example machine readable instructions and/or perform the example operations of FIG. 7 to implement the steering controller of FIG. 3.

In general, the same reference numbers will be used throughout the drawing(s) and accompanying written description to refer to the same or like parts. The figures are not necessarily to scale.

### DETAILED DESCRIPTION

In recent years, advanced driver assistance systems for automobiles have become more common. Some ADAS are path follower systems that generate a reference steering angle corresponding to a desired vehicle trajectory without active driver input. Some such ADAS are shared steering control systems, which enable a driver to have control over the vehicle trajectory without deactivating the ADAS. These systems enable a driver to affect (e.g., edit, change, modify, etc.) the trajectory of the vehicle via inputs to the steering wheel, which enables a driver to modify the operation of the ADAS without the deactivation thereof. Additionally, the control of the vehicle trajectory offered by shared steering control systems enhances the driving feel of the vehicle for drivers of the vehicle. An example shared-control ADAS is described in U.S. patent application Ser. No. 18/491,557, which is hereby incorporated by reference in its entirety. In some prior shared-control ADAS, the input variables of the driver-controlled input of the system are not limited or bounded. As a result, the inputs of the driver could overcorrect the reference angle, particularly when the driver moves from a hands-off to a hands-on position and/or at high vehicle speeds. Such overcorrections can diminish the driving experience for the driver.

Examples disclosed herein overcome some or all of the above-noted problems and include limiters that limit the driver input on shared-control ADAS. Examples disclosed herein include a driving system that combines a reference angle output by an ADAS and an angle overlay associated with an input of the driver. Examples disclosed herein include a steering controller, which limits (e.g., bounds, etc.) the angle overlay generated by the driver. In some examples disclosed herein, the steering controller determines the limit(s) on the angle overlay based on an activity level of the driver and a speed of the vehicle. In some such examples disclosed herein, the limits on the angle overlay determined by the steering controller are inversely proportional to vehicle speed and proportional to driver activity. Some examples disclosed herein apply a rate limit to the angle overlay. Some examples disclosed herein apply a magnitude limit to the angle overlay. Some examples disclosed herein deactivate the ADAS when the limit is exceeded. Examples disclosed herein mitigate (e.g., reduce, mitigate, etc.) overcorrections of the vehicle trajectory by the driver, which enhances the feel of the vehicle and the experience of the driver.

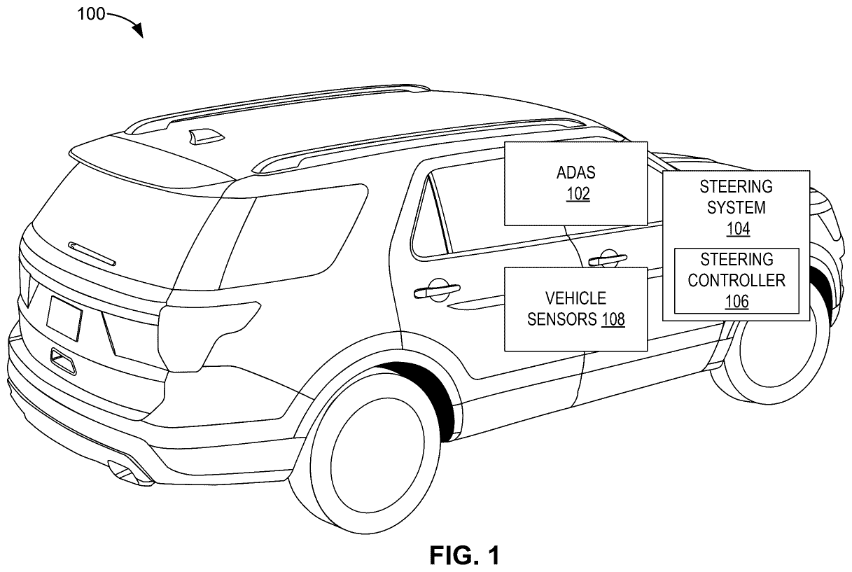

FIG. 1 illustrates an example vehicle 100 implemented in accordance with teachings of this disclosure. In the illustrated example of FIG. 1, the vehicle 100 includes an example ADAS 102, an example steering system 104, an example steering controller 106, and example vehicle sensors 108. The vehicle 100 is a motorized wheel-driven vehicle. In the illustrated example of FIG. 1, the vehicle 100 is a sport utility vehicle (SUV). In other examples, the vehicle 100 can be any type of wheeled vehicle (e.g., a sedan, a coupe, a van, a pick-up, an all-terrain vehicle (ATV), farming equipment, etc.). In some examples, the vehicle 100 includes an internal combustion engine (e.g., a non-electrified vehicle, a partially electrified vehicle, a hybrid, etc.). In other examples, the vehicle 100 is a fully electric vehicle.

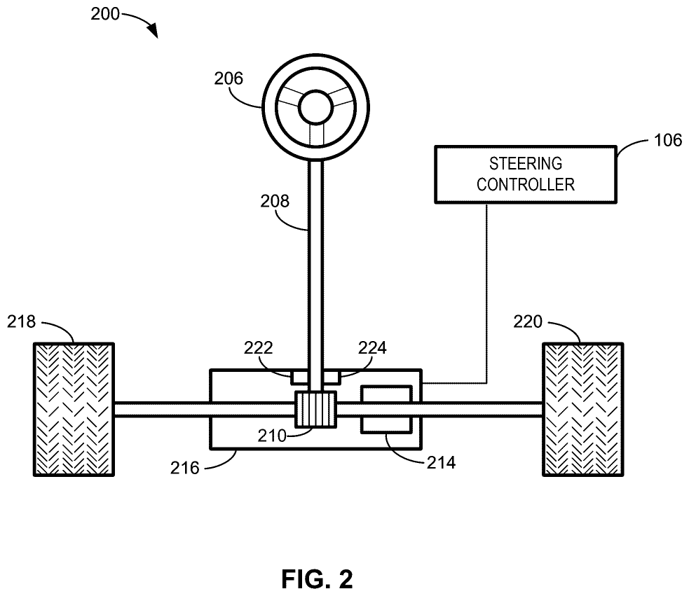

The steering system 104 allows a driver of the vehicle 100 to control/steer the vehicle 100. In some examples, the steering system 104 includes a mechanical linkage between a user interface of the vehicle 100 (e.g., a steering wheel, etc.) and the wheels of the vehicle 100 (e.g., via a steering column and rack and pinion system, etc.). For example, the steering system 104 can include an electric powered steering system. In other examples, the steering system 104 can include any suitable type of powered steering and/or steering assist (e.g., hydraulic, hybrid electro-hydraulic systems, etc.). Additionally or alternatively, the steering system 104 can include other mechanisms (e.g., external angle controllers (EAC), one or more actuators, etc.) that interface with the ADAS 102 and/or the steering controller 106 and enable the navigation direction of the vehicle 100 to be adjusted without direct input from the driver. In some examples, the steering system 104 is a steer-by-wire system and/or a partially steer-by-wire system. An example implementation of the steering system 104 is described below in conjunction with FIG. 2.

The ADAS 102 interfaces with the systems of the vehicle 100 and/or the steering controller 106 to assist with the steering of the vehicle 100 and/or direct the vehicle along a target path. In some examples, the ADAS 102 is level 2 ADAS and/or a level 3 ADAS. In some such examples, the ADAS 102 is a path follower (PF) system. As used herein, the vehicle 100 is in a driver assist mode when the ADAS 102 is active. In some examples, the ADAS 102 can be activated and deactivated by an operator of the vehicle 100 interfacing with a user interface of the vehicle 100 (e.g., a dash-display, a button, a switch, a microphone, etc.) and/or a personal device of the operator (e.g., a smartphone, a smartwatch, etc.). While the vehicle 100 is in a driver assist mode, the ADAS 102 generates a reference angle to direct the vehicle 100 along a target path. References angles generated by the ADAS 102 are also referred to herein as path follower angle requests and automation reference angles. In some examples, the reference angle generated by the ADAS 102 is based on the destination of the vehicle 100 and the ambient conditions of the vehicle 100 (e.g., the presence of other vehicles, pedestrians, and/or obstacles, the road the vehicle 100 is operating on, weather conditions, etc.) and is otherwise independent of driver input.

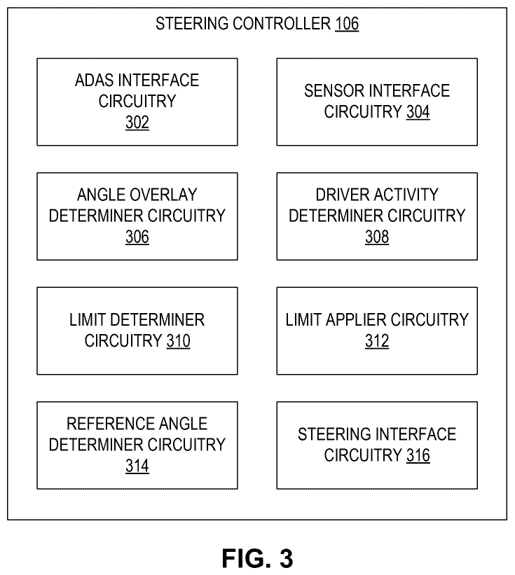

The steering controller 106 regulates and/or controls the operation of the steering system 104 of the vehicle 100. In some examples, the steering controller 106 receives input from a user interface of the vehicle 100 that enables a driver of the vehicle 100 to navigate the vehicle 100 (e.g., a steering wheel, etc.). In some examples, when the ADAS 102 is active (e.g., the ADAS 102 is generating a reference angle, etc.), the steering controller 106 can generate an angle overlay based on the input to the user interface of the steering system 104. In some examples, the steering controller 106 combines the angle overlay with the reference angle output by the ADAS 102 to generate a modified reference angle, which is then applied to the steering system 104 to steer the vehicle 100. In some examples, the combination of the reference angle and the angle overlay enables the driver to have control over the vehicle 100 without deactivating the ADAS 102. In some examples, the steering controller 106 can modify (e.g., limit, bound, etc.) the generated angle overlay based on a driver activity metric (e.g., a driver activity level, driver activity, etc.) and/or the speed of the vehicle 100. In some examples, the steering controller 106 modifies the angle overlay with a magnitude limit. Additionally or alternatively, the steering controller 106 modifies the angle overlay with a rate limit. An example implementation of the steering controller 106 is described below in conjunction with FIG. 3. In some examples, some or all of the steering controller 106 can be implemented by an electronic control unit (ECU) of the vehicle 100. Additionally or alternatively, some or all of the steering controller 106 can be implemented by another suitable computer (e.g., another computer of the vehicle 100, a mobile device of a user of the vehicle 100, a remote computer, etc.).

The vehicle sensors 108 include one or more sensors that measure different metrics related to the vehicle 100. For example, the vehicle sensors 108 can measure metrics related to the steering system 104, such as the position of a steering wheel, a speed of the steering wheel, a torque applied to the steering wheel, a position of the steering system (e.g., a position of the steering rack and pinion, etc.), system parameters related to the power steering system, etc. In some examples, the vehicle sensors 108 can include one or more speedometers that enable a speed of the vehicle 100 to be determined. In some examples, the steering controller 106 interfaces with the vehicle sensors 108 to receive the sensor outputs thereof.

FIG. 2 is a schematic of an example steering system 200 of the example vehicle 100 of FIG. 1. The steering system 200 of FIG. 2 can implement the steering system 104 of FIG. 1. In other examples, the steering system 104 of FIG. 1 can be implemented by a different type of steering system (e.g., a different type of mechanical steering system, a steer-by-wire system, etc.). In the illustrated example of FIG. 2, the steering system 200 includes an example steering wheel 206, an example steering column 208, an example steering gear 210, an example steering motor 214, an example first steered wheel 218, an example second steered wheel 220, an example steering torque sensor 222, and an example steering wheel angle sensor 224.

The steering wheel 206 is a user interface that enables a driver of the vehicle 100 to interface with the steering system 104. In the illustrated example of FIG. 2, the steering wheel 206 is mechanically connected to the first steered wheel 218 and the second steerable wheel 220. In the illustrated example of FIG. 2, the steering wheel 206 is coupled to the steered wheels 218, 220 via the steering column 208 and the steering gear 210. The steering column 208 mechanically couples the steering wheel 206 to the steering gear 210. In the illustrated example of FIG. 2, the steering column 208 is a single shaft that extends between the steering wheel 206 and the steering gear 210. In other examples, the steering column 208 includes two or more interconnected shafts. In some such examples, the steering column 208 can include a first steering shaft coupled to a second steering shaft via a universal joint (U-joint).

The steering gear 210 is an actuator, which translates rotational inputs from the steering column 208 into motion of the steered wheels 218, 220. As the driver applies torque to the steering wheel 206, the steering gear 210 rotates and provides a linear force via the linkages coupled to the steered wheels 218, 220. In the illustrated example of FIG. 2, the steering gear 210 is a rack and pinion steering system. In other examples, the steering gear 210 can be implemented by another type of steering system (e.g., a recirculating ball steering gear, a worm and sector steering gear, a worm and nut steering gear, etc.). In some examples, the steering gear 210 has a fixed gear ratio. In other examples, the steering gear 210 has a variable gear ratio. In some examples, the steering gear 210 is mounted to a frame and/or a body of the vehicle 100. In the illustrated example of FIG. 2, the steering gear 210 is disposed within an example housing 216. The steered wheels 218, 220 are the wheels of the vehicle 100 that are moveably coupled to the steering system 200. In the illustrated example of FIG. 2, the steered wheels 218, 220 are the front wheels of the vehicle 100 (e.g., the first steered wheel 218 is the front passenger side wheel, the second steerable wheel 220 is the front driver side wheel, etc.). In other examples, the steered wheels 218, 220 are the rear wheels of the vehicle.

The steering motor 214 applies torque to the steering system 200. In the illustrated example of FIG. 2, the steering motor 214 is coupled to the steering gear 210 and disposed within the housing 216. In other examples, the steering motor 214 is disposed at another location of the steering system 200 (e.g., on the steering column 208, etc. During operation, the steering motor 214 applies a torque to the steering gear 210, which corresponding moves the steering wheel 206 and the steered wheels 218, 220. In the illustrated example of FIG. 2, the ADAS 102 and/or the steering controller 106 can operate the steering motor 214 to adjust the steering angle of the steering wheel 206 and the road wheel angle of the first steered wheel 218 and second steered wheel 220 to steer the vehicle 100.

In the illustrated example of FIG. 2, the steering motor 214 is an independent device. In other examples, the steering motor 214 can be a component of the power steering system of the vehicle 100. In such examples, the steering motor 214 can provide power steering assistance to the steering system 200. For example, during conventional operation of the vehicle 100 (e.g., when the vehicle 100 is not in a driver assist mode, etc.), the steering controller 106 can operate the steering motor 214 to provide additional torque assistance for steering the vehicle 100 based on the torque applied to the steering wheel 206. Additionally or alternatively, the steering controller 106 and/or the ADAS 102 can operate the steering motor 214 to control the steering angle of the steering wheel 206 while the vehicle 100 is in a driver assist mode. For example, the steering controller 106 can provide a reference angle and/or a torque request to the steering motor 214 to cause the steering motor 214 to adjust a position of the steered wheels 218, 220 and/or the steering wheel 206.

The steering torque sensor 222 measures the steering torque applied to the steering column 208. In the illustrated example of FIG. 2, the steering torque sensor 222 is disposed near the bottom of the steering column 208. In other examples, the steering torque sensor 222 can be coupled to an upper portion of the steering column 208. The steering torque sensor 222 measures the torque exerted by the driver on the steering system 200. In some examples, the steering torque sensor 222 can be implemented by any suitable means of measuring applied torque (e.g., a magnetoelastic torque sensor, a rotary strain gauge, etc.). Additionally or alternatively, the steering torque may be derived from any other suitable measurable quantities. As used herein, the raw output of the steering torque sensor 222 is referred as the input steering torque. As used herein, the filtered and/or processed output of the steering torque sensor 222 is referred to as the driver torque estimate. In some examples, the output of the steering torque sensor 222 (e.g., the input steering torque, etc.) can be filtered via a Kalman filter to generate the driver torque estimate.

The steering wheel angle sensor 224 measures the rotational position of the steering wheel 206. In the illustrated example of FIG. 2, the steering wheel angle sensor 224 is disposed adjacent to the steering gear 210. Additionally or alternatively, the steering wheel angle sensor 224 can be disposed on the steering column 208. The steering wheel angle sensor 224 can be implemented by any suitable means of measuring steering angle (e.g., a rotary encoder, an optical encoder, a Hall-effect sensor, a resolver, a magnetic sensor, etc.). Additionally or alternatively, the steering angle may be derived from other metrics (e.g., steering velocity, steering acceleration, steering torque, etc.).

FIG. 3 is a block diagram of an example implementation of the steering controller 106 of FIG. 1 to generate, modify (e.g., limit, bound, etc.), and apply an angle overlay to the output of the ADAS 102. In the illustrated example of FIG. 3, the steering controller 106 includes example ADAS interface circuitry 302, example sensor interface circuitry 304, example angle overlay determiner circuitry 306, example driver activity determiner circuitry 308, example limit determiner circuitry 310, example limit applier circuitry 312, example reference angle determiner circuitry 314, and example steering interface circuitry 316. The steering controller 106 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the steering controller 106 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

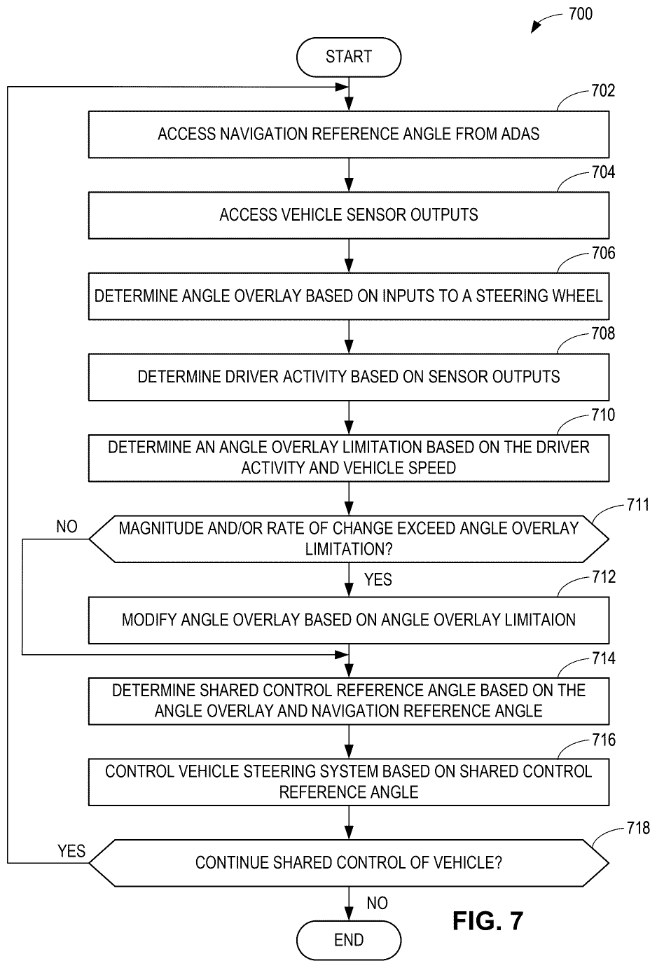

The ADAS interface circuitry 302 interfaces with the ADAS 102 of FIG. 1. For example, the ADAS interface circuitry 302 can access a reference angle from vehicle navigation from the ADAS 102. In some examples, the ADAS interface circuitry 302 interfaces with the ADAS 102 via one or more wireless and/or wired connections (e.g., via a controller area network (CAN) bus of the vehicle 100, etc.). In some examples, the ADAS interface circuitry 302 can send sensor data accessed via the sensor interface circuitry 304 to the ADAS 102 to enable the generation of the reference angle. In some examples, the ADAS interface circuitry 302 is instantiated by programmable circuitry executing ADAS interface instructions and/or configured to perform operations such as those represented by the flowchart of FIG. 7.

The sensor interface circuitry 304 accesses (e.g., requests, receives, etc.) sensor data from the sensors of the example vehicle 100 and the steering system 104. For example, the sensor interface circuitry 304 can receive input from the steering torque sensor 222, the steering wheel angle sensor 224, and/or the vehicle sensors 108 (e.g., a speedometer of the vehicle 100, etc.) via one or more wireless and/or wired connections (e.g., via a CAN bus of the vehicle 100, etc.). In some examples, the sensor interface circuitry 304 distributes received sensor data to at least one of the ADAS interface circuitry 302, the angle overlay determiner circuitry 306, the driver activity determiner circuitry 308, the limit determiner circuitry 310, the limit applier circuitry 312, the reference angle determiner circuitry 314, and/or the steering interface circuitry 316. In some examples, the sensor interface circuitry 304 is instantiated by programmable circuitry executing sensor interface instructions and/or configured to perform operations such as those represented by the flowchart of FIG. 7.

The angle overlay determiner circuitry 306 determines an angle overlay. As used herein, the phrases “angle overlay” and “boost curve” are used interchangeably to refer to the drive-related input to a shared-control ADAS. For example, the angle overlay determiner circuitry 306 can determine an angle overlay via the process described in conjunction with FIGS. 9-15 of U.S. patent application Ser. No. 18/491,557. Additionally or alternatively, the angle overlay determiner circuitry 306 can determine the angle overlay via sensor data accessed by the sensor interface circuitry 304. In some such examples, the angle overlay determiner circuitry 306 can determine the angle overlay via the steering wheel angle, the steering wheel torque, and/or one or other sensor outputs accessed by the sensor interface circuitry 304. In some examples, the angle overlay determiner circuitry 306 is instantiated by programmable circuitry executing angle overlay determiner instructions and/or configured to perform operations such as those represented by the flowchart of FIG. 7.

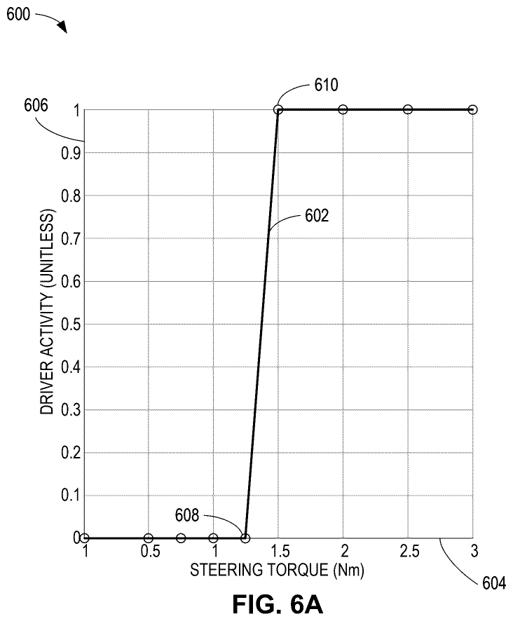

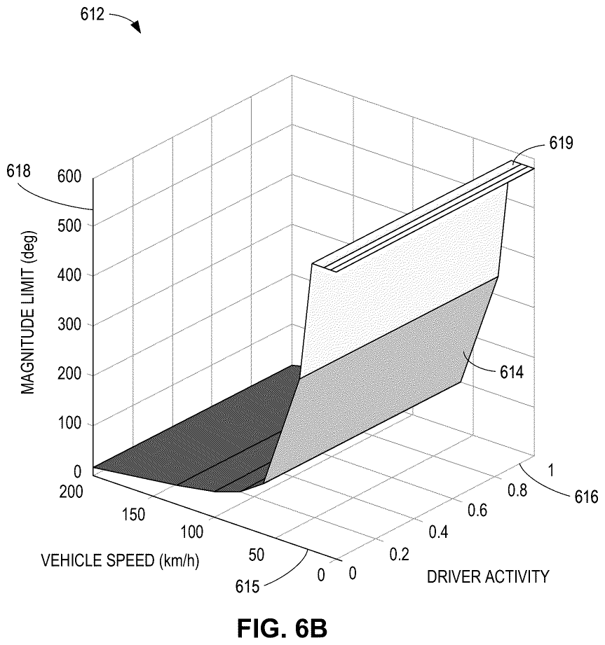

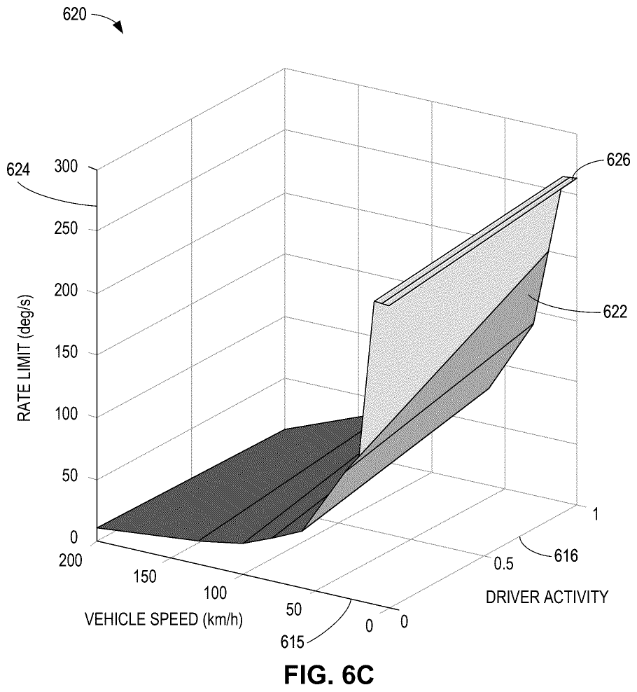

The driver activity determiner circuitry 308 determines a driver activity metric based on sensor inputs. For example, the driver activity determiner circuitry 308 can determine a driver activity metric associated with the presence of a driver's hands on the steering wheel 206 of the vehicle 100. In some examples, the driver activity determiner circuitry 308 determines the driver activity metric based on the applied driver torque and/or the steering torque. In some such examples, the driver activity determiner circuitry 308 can determine the driver activity metric based on a relationship curve and/or look-up table relating the applied driver torque and/or the steering torque. An example relationship curve that can be used by the driver activity determiner circuitry 308 is described below in conjunction with FIG. 6A.

In other examples, the driver activity determiner circuitry 308 determines the driver activity metric based on a sensor output associated with the physical presence of a hand on the steering wheel 206 (e.g., a tactile sensor on the steering wheel, a biometric sensor on the steering wheel 206, etc.). In some examples, the driver activity determiner circuitry 308 determines the driver activity metric as a value between 0 (e.g., complete confidence the hands of the driver are off the steering wheel 206, etc.) and 1 (e.g., complete confidence the hands of the driver are on the steering wheel 206, etc.). In some examples, the driver activity determiner circuitry 308 is instantiated by programmable circuitry executing driver activity determiner instructions and/or configured to perform operations such as those represented by the flowchart of FIG. 7.

The limiter determiner circuitry 310 determines a limit for the angle overlay determined by the angle overlay determiner circuitry 306. For example, the limiter determiner circuitry 310 can determine a magnitude limit for the angle overlay based on the driver activity metric determined by the driver activity determiner circuitry 308 and a speed of the vehicle 100. An example relationship curve that can be used by the limiter determiner circuitry 310 to determine a magnitude limit is described below in conjunction with FIG. 6B. Additionally or alternatively, the limiter determiner circuitry 310 can determine a rate limit (e.g., a rate of change limit, etc.) for the angle overlay based on the driver activity metric determined by the driver activity determiner circuitry 308 and a speed of the vehicle 100. An example relationship curve that can be used by the limiter determiner circuitry 310 to determine a rate limit is described below in conjunction with FIG. 6C. In other examples, the limit determiner circuitry 310 can determine a limit on the angle overlay in any other suitable manner (e.g., via a look-up table, via one or more mathematical calculations, etc.). In some examples, the limiter determiner circuitry 310 is instantiated by programmable circuitry executing limiter determiner instructions and/or configured to perform operations such as those represented by the flowchart of FIG. 7.

The limiter applier circuitry 312 modifies the angle overlay based on the angle overlay limit determined by the limit determiner circuitry 310 to generate a modified angle overlay (e.g., the bounded angle overlay, etc.). For example, the limit applier circuitry 312 can apply a rate limit to the angle overlay. Additionally or alternatively, the limit applier circuitry 312 can apply a magnitude limit to the angle overlay by the limit determiner circuitry 310 (e.g., only a magnitude limit, both a rate limit and a magnitude limit, etc.). Additionally or alternatively, the limit applier circuitry 312 can modify the rate limit based on a determined magnitude limit and apply the modified rate limit to the angle overlay. For example, the limit applier circuitry 312 can compare the angle overlay to the magnitude limit and set the rate limit to a value based on the comparison. In some such examples, if the angle overlay is less than the magnitude limit, the limit applier circuitry 312 can set the rate limit to the value determined by the limit determiner circuitry 310. In some such examples, if the angle overlay is greater than the magnitude limit, the limit applier circuitry 312 can set the rate limit to a fixed value. In some such examples, the fixed value is approximately zero. Additionally or alternatively, the limit applier circuitry 312 can deactivate the ADAS 102 if the rate of change of the angle overlay is greater than the rate limit and/or if the magnitude of the angle overlay is greater than the magnitude limit. In some such examples, the rate limit is a non-zero value. In some examples, the limiter applier circuitry 312 is instantiated by programmable circuitry executing limiter applier instructions and/or configured to perform operations such as those represented by the flowchart of FIG. 7.

The reference angle determiner circuitry 314 determines a new reference angle for navigation of the vehicle 100 based on the modified angle overlay determined by the limiter applier circuitry 312 and the reference angle accessed by the ADAS interface circuitry 302 of FIG. 3. For example, the reference angle determiner circuitry 314 can determine the new reference angle via the process described in conjunctions with FIG. 6 of U.S. patent application Ser. No. 18/491,557. In other examples, the reference angle determiner circuitry 314 can determine the new reference angle in any other suitable manner. In some examples, the reference angle determiner circuitry 314 is instantiated by programmable circuitry executing reference angle determiner instructions and/or configured to perform operations such as those represented by the flowchart of FIG. 7.

The steering interface circuitry 316 controls the vehicle steering system based on the new reference angle determined by the reference angle determiner circuitry 314. For example, the steering interface circuitry 316 can convert the new reference angle into a torque request based on the current position of the steering gear 210. In some such examples, the steering interface circuitry 316 can determine the torque request based on analytic calculations, a relationship curve, and/or a look-up table. In some examples, the steering interface circuitry 316 can cause the steering motor 214 to apply a torque to the steering gear 210 to cause a corresponding change in vehicle navigation based on the new reference angle determined by the reference angle determiner circuitry 314. In some examples, the steering interface circuitry 316 is instantiated by programmable circuitry executing reference steering interface instructions and/or configured to perform operations such as those represented by the flowchart of FIG. 7.

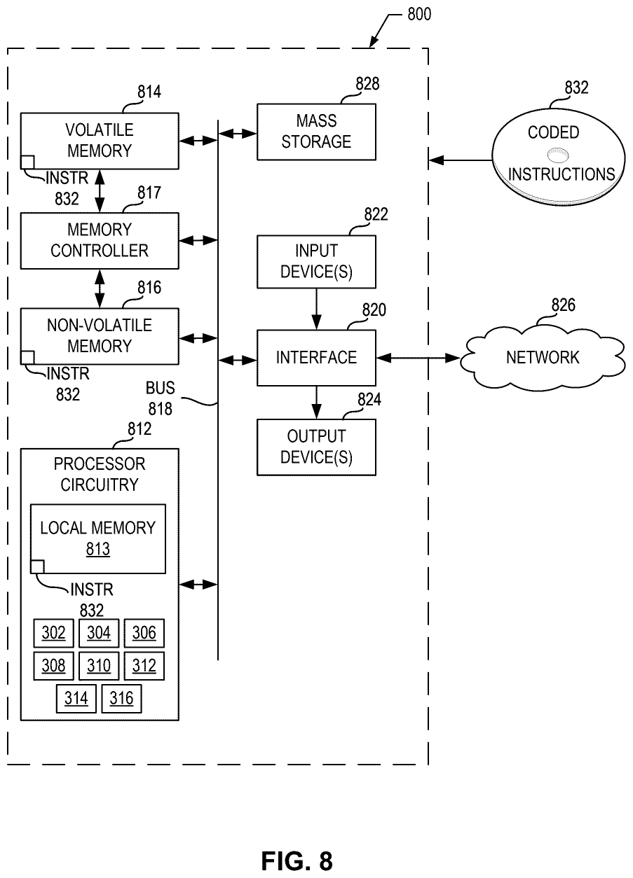

In some examples, the steering controller 106 includes means for interfacing with one or more sensors, means for interfacing with an ADAS of a vehicle, means for determining an angle overlay, means for determining driver activity, means for determining an angle overlay limit, means for applying a limit to an angle overlay, means for determining a reference angle, and/or means for interfacing with a steering system. For example, the means for interfacing with an ADAS of a vehicle may be implemented by the ADAS interface circuitry 302, the means for interfacing with one or more sensors may be implemented by the sensor interface circuitry 304, the means for determining an angle overlay may be implemented by the angle overlay determiner circuitry 306, the means for determining driver activity may be implemented by the driver activity determiner circuitry 308, the means for determining an angle overlay limit may be implemented by the limiter determiner circuitry 310, the means for determining may be implemented by the limiter applier circuitry 312, the means for determining a reference angle may be implemented by the reference angle determiner circuitry 314, and/or the means for interfacing with a steering system may be implemented by the steering interface circuitry 316. In some examples, the steering interface circuitry 316 may be instantiated by programmable circuitry such as the example programmable circuitry 812 of FIG. 8. In some examples, the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, and/or the steering interface circuitry 316 may be instantiated by hardware logic circuitry, which may be implemented by an ASIC, XPU, or FPGA circuitry configured and/or structured to perform operations corresponding to the machine readable instructions. Additionally or alternatively, the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, and/or the steering interface circuitry 316 may be instantiated by any other combination of hardware, software, and/or firmware. For example, the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, and/or the steering interface circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the steering controller 106 of FIG. 1 is illustrated in FIG. 3, one or more of the elements, processes, and/or devices illustrated in FIG. 3 may be combined, divided, re-arranged, omitted, eliminated, and/or implemented in any other way. Further, the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, the steering interface circuitry 316, and/or, more generally, the example steering controller 106 of FIG. 3, may be implemented by hardware alone or by hardware in combination with software and/or firmware. Thus, for example, any of the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, the steering interface circuitry 316, and/or, more generally, the example steering controller 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example steering controller 106 of FIG. 3 may include one or more elements, processes, and/or devices in addition to, or instead of, those illustrated in FIG. 3, and/or may include more than one of any or all of the illustrated elements, processes and devices.

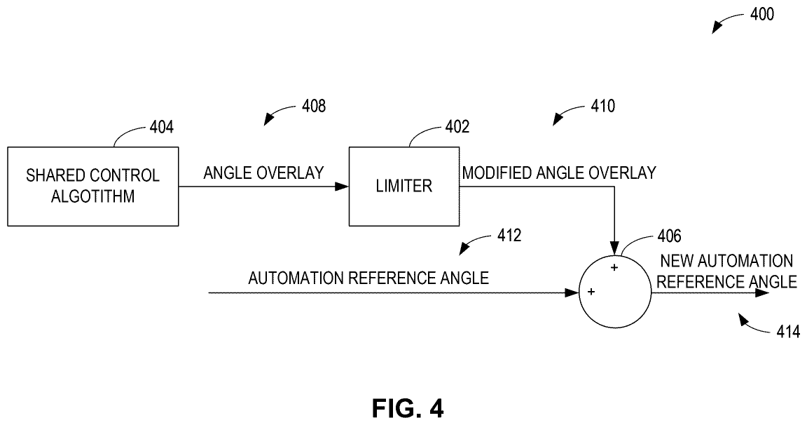

FIG. 4 is a schematic system diagram of an example shared-control driving system 400 including an example limiter 402 implemented in accordance with teachings of this disclosure. In the illustrated example of FIG. 4, the shared-control driving system 400 includes an example shared-control angle generator 404 and an example combiner 406. In the illustrated example of FIG. 4, the shared-control angle generator 404 generates an example angle overlay 408, which is input into the limiter 402. In the illustrated example of FIG. 4, the limiter 402 generates an example modified angle overlay 410 based on the angle overlay 408, which is input into the combiner 406. The example combiner 406 combines the modified angle overlay 410 and an example first reference angle 412 to generate an example second reference angle 414.

The shared-control angle generator 404 generates the angle overlay 408. For example, the shared-control angle generator 404 can generate the angle overlay 408 based on a position of the steering wheel 206 (e.g., the output of the steering wheel angle sensor 224 of FIG. 2, etc.), the torque applied to the steering wheel 206 (e.g., the output of the steering torque sensor 222 of FIG. 2, etc.), the ambient conditions of the vehicle 100, and/or any other inputs. In some examples, the shared-control angle generator 404 can be implemented by the angle overlay determiner circuitry 306 of FIG. 3. In some examples, the angle overlay 408 generated by the shared-control angle generator 404 is positive (e.g., corresponding to leftward navigation of the vehicle 100 and counterclockwise rotation of the steering wheel 206, etc.) or negative (e.g., corresponding to rightward navigation of the vehicle 100 and clockwise rotation of the steering wheel 206, etc.).

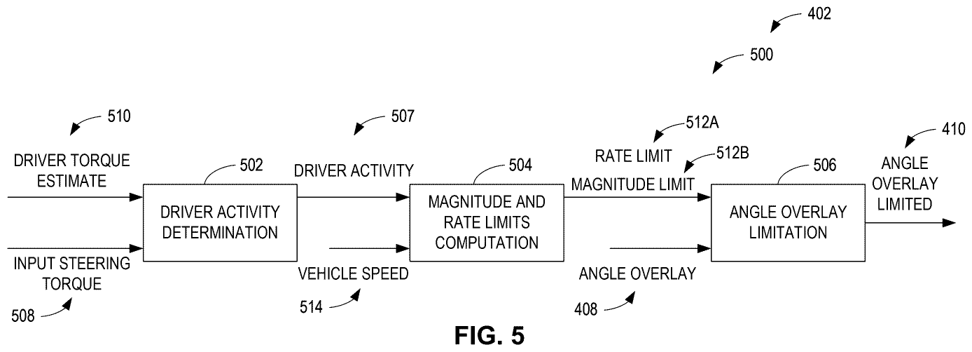

The limiter 402 modifies (e.g., limits, bounds, etc.) the angle overlay 408 to generate the modified angle overlay 410. In some examples, the limiter 402 can determine an activity level of a driver of the vehicle 100 (e.g., a driver activity metric, etc.). In some examples, the limiter 402 can determine limits for the angle overlay 408 based on the speed of the vehicle 100 and/or the activity level of a driver. In some examples, the limiter 402 can limit the rate of change and/or the magnitude of the angle overlay 408. An example implementation of the limiter 402 is described below in conjunction with FIG. 5. In some examples, the limiter 402 can be implemented by the driver activity determiner circuitry 308 of FIG. 3, the limit determiner circuitry 310 of FIG. 3, and the limit applier circuitry 312 of FIG. 3.

The first reference angle 412 is the unmodified output of the ADAS 102 of FIG. 1 and corresponds to the navigation direction determined thereby. For example, the ADAS 102 can determine the first reference angle 412 based on the current settings of the vehicle 100, the ambient conditions of the vehicle 100, and/or any other suitable characteristics. The first reference angle 412 is also referred to herein as the “automation reference angle” and the “unmodified reference angle.” In some examples, the first reference angle 412 is generated by the ADAS 102 and is accessed by the ADAS interface circuitry 302 of FIG. 3.

The combiner 406 combines the first reference angle 412 and the modified angle overlay 410 to generate the second reference angle 414. In some examples, the combiner 406 can combine the first reference angle 412 and the modified angle overlay 410 via the process described in conjunction with FIG. 6 of U.S. patent application Ser. No. 18/491,557. In other examples, the combiner 406 can combine the first reference angle 412 and the modified angle overlay 410 to generate the second reference angle 414 in any other suitable manner (e.g., a weighted average, multiplying, subtracting, etc.). The second reference angle 414 is also referred to herein as the “new reference angle,” the “modified reference angle,” and the “shared-control reference angle.” In some examples, the second reference angle 414 can be used to determine a torque request for the steering motor 214 of the steering system 200 of FIG. 2, which is used to operate the steering gear 210 of FIG. 2 to achieve the navigation of the vehicle 100 associated with the second reference angle 414. In some examples, the combiner 406 can be implemented by the angle overlay determiner circuitry 306 of FIG. 3.

FIG. 5 is a schematic system diagram of an example limiter 500, which can implement the limiter 402 of FIG. 4. In the illustrated example of FIG. 5, the limiter 500 includes example first operations 502, example second operations 504, and example third operations 506.

The first operations 502 include the determination of an example driver activity metric 507. For example, during the first operations 502, the driver activity metric 507 can be determined based on an example input steering torque 508 measured by the steering torque sensor 222 of FIG. 2. In some examples, the input steering torque 508 corresponds to the unprocessed (e.g., raw, etc.) sensor data accessed by the sensor interface circuitry 304 from the steering torque sensor 222. Additionally or alternatively, during the first operations 502, the driver activity metric 507 can be determined based on an example applied driver torque 510 measured by the steering torque sensor 222 of FIG. 2. In some examples, the applied driver torque 510 can be determined by filtering and/or processing the input steering torque 508. In some examples, the input steering torque 508 and/or the applied driver torque 510 can be input into a relationship curve, a look-up table, and/or used analytically to determine the driver activity metric 507. In some examples, the first operations 502 include the inputting of the input steering torque 508 and/or the applied driver torque 510 into the relationship curve of FIG. 6A. In some examples, the first operations 502 are conducted by the driver activity determiner circuitry 308 of FIG. 3.

The second operations 504 include the determination of an example rate limit 512A and an example magnitude limit 512B. For example, during the second operations 504, the limiter 500 can determine the limits 512A, 512B based on the driver activity metric 507 determined during the first operations 502 and an example vehicle speed 514. In some examples, the vehicle speed 514 can be accessed by the sensor interface circuitry 304 of FIG. 3 from the vehicle sensors 108 of FIG. 3.

In some examples, the driver activity metric 507 and/or the vehicle speed 514 can be input into a relationship curve, a look-up table, and/or used analytically to determine the rate limit 512A and the magnitude limit 512B. In some examples, the second operations 504 include the inputting of the driver activity metric 507 and/or the vehicle speed 514 into the relationship curve of FIG. 6B to determine the magnitude limit 512B. In some examples, the second operations 504 include the inputting of the driver activity metric 507 and/or the vehicle speed 514 into the relationship curve of FIG. 6C to determine the rate limit 512A. In some examples, the second operations 504 are conducted by the limit determiner circuitry 310 of FIG. 3.

The third operations 506 include the application of the limits 512A, 512B determined during the second operations 504 to the angle overlay 408. In some examples, after applying the limits 512A, 512B to the angle overlay 408, the limiter 500 outputs the modified angle overlay 410 of FIG. 4. In some examples, during the third operations 506, the limiter 500 can limit the rate of change of the angle overlay 408. For example, the limiter 500 can limit the rate of change of the angle overlay 408 in both the positive and negative directions. In some examples, the limiter 500 can have different rate limits of the angle overlay 408 in the positive and negative directions. In other examples, the limiter 500 can have the same rate limits to the rate of change of the angle overlay 408 in the positive and negative directions. In other examples, the limiter 500 limits the rate of change of the angle overlay 408 in a single direction (e.g., based on the current navigation trajectory of the vehicle 100, etc.).

In some examples, the limiter 500 can limit the magnitude of the angle overlay 408. For example, the limiter 500 can limit the absolute value of the angle overlay 408. That is, the limiter 500 can limit the magnitude of the angle overlay 408 in both the positive and negative direction. In other examples, the limiter 500 limits the magnitude of the angle overlay 408 in a single direction (e.g., based on the current navigation trajectory of the vehicle 100, etc.). In some examples, the limiter 500 can apply both a magnitude limit and a rate limit to the angle overlay 408. In some examples, the limiter 500 can apply the rate limit 512A by deactivating the ADAS 102 of FIG. 1 and/or the shared-control driving system 400 of FIG. 4 if the rate of change of the angle overlay 408 is greater than the rate limit 512A. In some examples, the limiter 500 can apply the magnitude limit 512B by deactivating the ADAS 102 of FIG. 1 and/or the shared-control driving system 400 of FIG. 4 if the angle overlay 408 is greater than the magnitude limit 512B.

Additionally or alternatively, during the third operations 506, the limiter 500 can modify the rate limit 512A based on the magnitude limit 512B. For example, the limiter 500 can modify the rate limit 512A based on the following equations:

$$If Angle\_Overlay > abs ( ML ) , set RL\_Pos = 0 else set RL\_Pos = abs ( RL ) \qquad ( 1 )$$

$$If Angle\_Overlay < - abs ( ML ) , set RL\_Neg = 0 else set RL\_Neg = abs ( RL ) \qquad ( 2 )$$

where Angle_Overlay is the angle overlay 408, ML is the magnitude limit 512B, RL is the rate limit 512A, RL_Pos is the modified rate limit in the positive direction, and RL_Neg is the modified rate limit in the negative direction. That is, if the magnitude of the angle overlay 408 is greater than the magnitude limit 512B, the limiter 500 can set the rate limit 512A in the positive direction to a first fixed value and does not modify the rate limit 512A in the negative direction. If the magnitude of the angle overlay 408 is greater than the negative of the magnitude limit 512B, the limiter 500 does not modify the rate limit 512A in the positive direction and sets the rate limit in the negative direction to a second fixed value. If the magnitude of the angle overlay 408 is within the magnitude limit 512B in both directions, the limiter 500 does not modify the rate limit 512A. In some such examples, the first fixed value and the second fixed value are approximately zero. Additionally or alternatively, one or both of the first fixed value and the second fixed value can have different values. In some examples, the third operations 506 are conducted by the limit applier circuitry 312 of FIG. 3.

FIG. 6A is an example chart 600 depicting an example first relationship curve 602 between driver torque and a driver activity level. In some examples, the driver activity determiner circuitry 308 can use the chart 600 to determine a driver activity metric used by the limit determiner circuitry 310 to determine an angle overlay limit. In the illustrated example of FIG. 6A, the chart 600 includes an example x-axis 604 and an example y-axis 606. In the illustrated example of FIG. 6A, the x-axis 604 measures the applied driver torque and ranges between 0 and 3 Newton-meters (N-m). In the illustrated example of FIG. 6A, the y-axis 606 measures a driver activity, ranges between 0 and 1, and is unitless. It should be appreciated that because the driver activity is unitless, the range of the y-axis 606 is arbitrary and the driver activity metric can range between any two suitable values.

In the illustrated example of FIG. 6A, the first relationship curve 602 is generally ramp-shaped and includes an example first inflection point 608 and an example second inflection point 610. In the illustrated example of FIG. 6A, the relationship curve 602 has a value of zero to the left of the first inflection point 608, a value of one to the right of the second inflection point 610, and/or ramps linearly between the inflection points 608, 610. In other examples, the first relationship curve 602 can have a curvature between the inflection points 608, 610 (e.g., a concave curvature, a convex curvature, etc.). In some examples, the shape of the first relationship curve 602 and/or the position of the inflection points 608, 610 can be calibrated based on the model of the vehicle 100 and/or the platform on which the vehicle 100 is based. For example, the shape of the first relationship curve 602 and/or the position of the inflection points 608, 610 can be calibrated such that the y-values of 0 on the first relationship curve 602 correspond to a certainty that the hands of the driver are off the steering wheel 206 for a given torque and y-values of 1 on the first relationship curve 602 correspond to certainty that the hands of the driver are on the steering wheel 206 for a given torque. In some such examples, the shape of the first relationship curve 602 and/or the position of the inflection points 608, 610 can be calibrated based on the stiffness of the steering system 104 and/or expected noise and/or accuracy of the steering torque sensor 222. In other examples, the first relationship curve 602 can have other shapes. For example, the first relationship curve 602 can be a step function (e.g., the inflection points 608, 610 are aligned along the x-axis 604, etc.).

FIG. 6B is an example second chart 612 depicting an example second relationship curve 614 between vehicle speed, driver activity, and the magnitude limit 512B of FIG. 5. In some examples, the limit determiner circuitry 310 can use the second chart 612 to determine the magnitude limit 512B based on the driver activity metric determined by the driver activity determiner circuitry 308 and the speed of the vehicle 100. In the illustrated example of FIG. 6B, the second relationship curve 614 relates the magnitude limit 512B to a vehicle speed and a driver activity. That is, in the illustrated example of FIG. 6B, the maximum allowable value of the angle overlay 408 is a function of vehicle speed and driver activity. In the illustrated example of FIG. 6B, the second chart 612 includes an example x-axis 615, an example y-axis 616, and an example z-axis 618. In the illustrated example of FIG. 6B, the x-axis 615 measures the speed and/or the velocity of the vehicle 100 and ranges between 0 and 200 kilometers per hour. In the illustrated example of FIG. 6B, the y-axis 616 measures the driver activity, ranges between 0 and 1, and is unitless. In the illustrated example of FIG. 6B, the z-axis 618 measures the magnitude limit 512B and ranges from 0 to 600 degrees. The magnitude limit 512B of the z-axis 618 corresponds to the maximum allowable value of the angle overlay 408 of FIG. 4.

In the illustrated example of FIG. 6B, the second relationship curve 614 is generally convexly shaped with respect to the x-y plane. In the illustrated example of FIG. 6B, the shape of the second relationship curve 614 indicates that the magnitude limit 512B is inversely proportional to the speed of the vehicle 100 and the magnitude limit 512B is proportional to the driver activity metric. In the illustrated example of FIG. 6B, the effect of the vehicle speed (e.g., the x-axis 615, etc.) on the shape of the second relationship curve 614 is greater than the effect of the driver activity (e.g., the y-axis 616, etc.). That is, in the illustrated example of FIG. 6B, the vehicle speed has a greater weight on the second relationship curve 614 than the driver activity. In the illustrated example of FIG. 6B, the second relationship curve 618 has an example maxima 619, which occurs at values on the x-axis 615 of less than 10 km/h and is approximately independent of the y-axis 616. In the illustrated example of FIG. 6B, the maxima 619 is approximately 600 degrees. In other examples, the maxima 619 has a different value or is absent. In some examples, the second relationship curve 614 can have other shapes and/or the vehicle speed and the driver activity can have different weights. For example, the second relationship curve 614 can be a step function, a ramp function, and/or a have different curvature (e.g., a concave curvature, a polymetric curvature, a sinusoidal curvature, etc.). In some examples, the shape of the second relationship curve 614 can be calibrated and/or tuned via vehicle testing and can be based on the accuracy of the sensors 222, 224 of FIG. 2 and/or the vehicle sensors 108, the make/model of the vehicle 100, controllability goals of a manufacturer of the vehicle 100, and/or one or more industry and/or regulatory standards.

FIG. 6C is an example third chart 620 depicting an example third relationship curve 622 between vehicle speed, driver activity, and the rate limit 512A of FIG. 5A. In some examples, the limit determiner circuitry 310 can use the third chart 620 to determine the rate limit 512A (e.g., a rate of change limit, etc.) based on the driver activity metric determined by the driver activity determiner circuitry 308 and the speed of the vehicle 100. In the illustrated example of FIG. 6, the third relationship curve 622 relates the rate limit 512A of FIG. 5A to a vehicle speed and a driver activity metric. That is, in the illustrated example of FIG. 6C, the maximum allowable rate of change of the angle overlay 408 is a function of vehicle speed and driver activity. In the illustrated example of FIG. 6C, the second chart 612 includes the x-axis 615 of FIG. 6B, the y-axis 616 of FIG. 6B, and an example z-axis 624. In the illustrated example of FIG. 6C, the z-axis 624 measures the rate limit 512A of FIG. 5A and ranges from 0 to 300 degrees per second. The rate limit 512A of the z-axis 624 corresponds to the maximum rate of change of the angle overlay 408 of FIG. 4.

In the illustrated example of FIG. 6C, the third relationship curve 622 is generally convexly shaped with respect to the x-y plane. In the illustrated example of FIG. 6C, the shape of the third relationship curve 622 indicates that the magnitude limit is inversely proportional to the speed of the vehicle 100 and the magnitude limit is proportional to the driver activity metric. In the illustrated example of FIG. 6C, the effect of the vehicle speed (e.g., the x-axis 615, etc.) on the shape of the third relationship curve 622 is more than the effect of the driver activity (e.g., the y-axis 616, etc.). That is, in the illustrated example of FIG. 6C, the vehicle speed has a greater weight on the third relationship curve 622 than the driver activity. It should be appreciated that the driver activity metric has a comparatively greater weight on the third relationship curve 622 than the second relationship curve 614 of FIG. 6B.

In the illustrated example of FIG. 6C, the third relationship curve 622 has an example maxima 626, which occurs at values on the x-axis 615 of less than 5 km/h and is approximately independent of the y-axis 616. In the illustrated example of FIG. 6C, the maxima 626 is approximately 300 degrees per second. In other examples, the maxima 624 has a different value or is absent. In some examples, the third relationship curve 622 can have other shapes and/or the vehicle speed and the driver activity can have different weights. For example, the third relationship curve 622 be a step function, a ramp function, and/or a different curvature (e.g., a concave curvature, a polymetric curvature, a sinusoidal curvature, etc.). In some examples, the shape of the third relationship curve 622 can be calibrated and/or tuned via vehicle testing and can be based on the accuracy of the sensors 222, 224 of FIG. 2 and/or the vehicle sensors 108, the make/model of the vehicle 100, controllability goals of a manufacturer of the vehicle 100, and/or one or more industry and/or regulatory standards.

A flowchart representative of example machine readable instructions, which may be executed by programmable circuitry to implement and/or instantiate the steering controller 106 of FIG. 3 and/or representative of example operations which may be performed by programmable circuitry to implement and/or instantiate the steering controller 106 of FIG. 3, are shown in FIG. 7. The machine readable instructions may be one or more executable programs or portion(s) of one or more executable programs for execution by programmable circuitry such as the programmable circuitry 812 shown in the example programmable circuitry platform 800 discussed below in connection with FIG. 8. In some examples, the machine readable instructions cause an operation, a task, etc., to be carried out and/or performed in an automated manner in the real world.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example steering controller 106 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to generate, modify (e.g., limit, bound, etc.), and apply an angle overlay to the output of the ADAS 102. The example machine-readable instructions and/or the example operations 700 of FIG. 7 begin at block 702, at which the ADAS interface circuitry 302 accesses a navigation reference angle from the ADAS 102. For example, the ADAS interface circuitry 302 can access (e.g., request, receive, etc.) a reference angle generated by the ADAS 102 via one or more wireless and/or wired connections (e.g., via a CAN bus of the vehicle 100, etc.). At block 704, the sensor interface circuitry 304 accesses the outputs of the vehicle sensor 108. For example, the sensor interface circuitry 304 can receive input from the steering torque sensor 222, the steering wheel angle sensor 224, and/or any other sensors (e.g., a speedometer of the vehicle 100, etc.) via one or more wireless and/or wired connections (e.g., via a CAN bus of the vehicle 100, etc.). In other examples, the sensor interface circuitry 304 can receive some or all of the sensor data from the vehicle sensors 108 via a manual input from an operator of the vehicle 100.

At block 706, the angle overlay determiner circuitry 306 determines the angle overlay 408 of FIG. 4 based on inputs to the steering wheel 206. For example, the angle overlay determiner circuitry 306 can determine the angle overlay 408 via the process described in conjunction with FIGS. 9-15 of U.S. patent application Ser. No. 18/491,557. Additionally or alternatively, the angle overlay determiner circuitry 306 can determine the angle overlay 408 via sensor data accessed by the sensor interface circuitry 304. In some such examples, the angle overlay determiner circuitry 306 can determine the angle overlay 408 via the steering wheel angle, the steering wheel torque, and/or one or other received sensor inputs.

At block 708, the driver activity determiner circuitry 308 determines a driver activity based on sensor inputs. For example, the driver activity determiner circuitry 308 determines the driver activity metric 507 of FIG. 5 associated with the presence of a driver's hands on the steering wheel 206 of the vehicle 100. In some examples, the driver activity determiner circuitry 308 determines the driver activity metric 507 based on the applied driver torque and/or the input steering torque. In some such examples, the driver activity determiner circuitry 308 can determine the driver activity metric 507 based on the first relationship curve 602 of FIG. 6A. In other examples, the driver activity determiner circuitry 308 can determine the driver activity metric 507 based on a sensor output associated with the physical presence of a hand on the steering wheel 206.

At block 710, the limit determiner circuitry 310 determines an angle overlay limit based on the determined driver activity and vehicle speed. For example, the limit determiner circuitry 310 can determine the rate limit 512A of FIG. 5 for the angle overlay 408 of FIG. 4 based on the driver activity metric 507 and the speed of the vehicle 100. Additionally or alternatively, the limit determiner circuitry 310 determines the magnitude limit 512B of FIG. 5 for the angle overlay 408 of FIG. 4 based on the driver activity metric 507 and the speed of the vehicle 100. In some examples, the limit determiner circuitry 310 determines the magnitude limit 512B via the second relationship curve 614 of the second chart 612 of FIG. 6B and/or the rate limit 512A of the third relationship curve 622 of the third chart 620 of FIG. 6C. In other examples, the limit determiner circuitry 310 can determine the limits 512A, 512B in any other suitable manner (e.g., via a look-up table, via one or more mathematical calculations, etc.).

At block 711, the limit applier circuitry 312 determines if the magnitude and/or rate of change of the angle overlay 408 exceeds the limits 512A, 512B. For example, the limit applier circuitry 312 can determine a rate of change of the angle overlay 408 (e.g., based on immediately previous magnitudes of the angle overlay 408, etc.) and compare the rate of change to the rate limit 512A. Additionally or alternatively, the limit applier circuitry 312 can compare the magnitude of the angle overlay 408 to the magnitude limit 512B. If the limit applier circuitry 312 determines the magnitude and/or rate of change of the angle overlay 408 exceeds one or more of the limits 512A, 512B, the operations 700 advance to block 712. If the limit applier circuitry 312 determines the magnitude and/or rate of change of the angle overlay 408 does not exceed one or more of the limits 512A, 512B, the operations 700 advance to block 714.

At block 712, the limit applier circuitry 312 modifies the angle overlay 408 based on the angle overlay limit to generate the modified angle overlay 410. For example, the limit applier circuitry 312 can deactivate the ADAS 102 if the rate of change of the angle overlay 408 is greater than the rate limit 512A and/or if the magnitude of the angle overlay 408 is greater than the magnitude limit 512B. Additionally or alternatively, the limit applier circuitry 312 can apply the rate limit 512A to the angle overlay 408 by capping the rate of change of the angle overlay 408 to the rate limit 512A. Additionally or alternatively, the limit applier circuitry 312 can apply the magnitude limit 512B to the angle overlay 408 by the limit determiner circuitry 310 by capping the absolute value of the angle overlay 408 to the magnitude limit 512B. Additionally or alternatively, the limit applier circuitry 312 can modify the rate limit based on a determined magnitude limit and apply the modified rate limit to the angle overlay 408 by the limit determiner circuitry 310. For example, the limit applier circuitry 312 can compare the angle overlay 408 to the magnitude limit 512B and set the rate limit 512A to a value based on the comparison.

At block 714, the reference angle determiner circuitry 314 determines the second reference angle 414 based on the modified angle overlay 410 and the first reference angle 412. For example, the reference angle determiner circuitry 314 determines the second reference angle 414 for navigation of the vehicle 100 based on the modified angle overlay 410 determined by the limiter applier circuitry 312 and the first reference angle 412 accessed by the ADAS interface circuitry 302 of FIG. 3. For example, the reference angle determiner circuitry 314 can determine the second reference angle 414 via the process described in conjunction with FIG. 6 of U.S. patent application Ser. No. 18/491,557. In other examples, the reference angle determiner circuitry 314 can determine the second reference angle 414 in any other suitable manner.

At block 716, the steering interface circuitry 316 controls the vehicle steering system based on the second reference angle 414. For example, the steering interface circuitry 316 can convert the second reference angle 414 into a torque request based on the current position of the steering gear 210 of FIG. 2. In some such examples, the steering interface circuitry 316 can determine the torque request based on analytic calculations, a relationship curve, and/or a look-up table. In some examples, the steering interface circuitry 316 can cause the steering motor 214 of FIG. 2 to apply a torque to the steering gear 210 to cause a corresponding change in vehicle navigation based on the second reference angle 414.

At block 718, the ADAS interface circuitry 302 determines if shared control of the vehicle 100 is to continue. For example, the ADAS interface circuitry 302 can determine that shared control is not to continue if the ADAS 102 is deactivated (e.g., via a command by a driver of the vehicle 100, automatically, etc.) and/or if the operation of the vehicle 100 ends (e.g., an engine of the vehicle 100 is turned off, the vehicle 100 is shifted into park, etc.). If shared control is to continue, the operations 700 return to block 702. If shared control is not to continue, the operations 700 end. It should be appreciated that the operations 700 may be repeated continuously while the vehicle 100 is in a driver assist mode (e.g., the ADAS 102 is deactivated, etc.).

FIG. 8 is a block diagram of an example programmable circuitry platform 800 structured to execute and/or instantiate the example machine-readable instructions and/or the example operations of FIG. 7 to implement the steering controller 106 of FIG. 3. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the ADAS interface circuitry 302, the sensor interface circuitry 304, the angle overlay determiner circuitry 306, the driver activity determiner circuitry 308, the limit determiner circuitry 310, the limit applier circuitry 312, the reference angle determiner circuitry 314, and the steering interface circuitry 316.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that adjust the steering wheel angle of a shared-control ADAS. Examples disclosed herein prevent intendedly large responses in shared-control ADAS. Disclosed systems, apparatus, articles of manufacture, and methods are accordingly directed to one or more enhancement(s) in the operation of a machine such as a computer or other electronic and/or mechanical device.

Example methods and apparatus for shared steering control for driver assist vehicles are disclosed herein. Further examples and combinations thereof include the following:

Example 1 includes a vehicle including a user interface, a driver-assistance system to generate a first reference navigation angle, and a controller to determine an angle overlay based on an input to the user interface, determine an angle overlay limit based on a driver activity and a speed of the vehicle, modify the angle overlay based on the angle overlay limit to generate a modified angle overlay, determine a second reference navigation angle based on the modified angle overlay and the first reference navigation angle, and control the vehicle based on the second reference navigation angle.

Example 2 includes the vehicle of any preceding example, wherein the user interface is a steering wheel and the controller is further to determine the driver activity based on a torque applied to the steering wheel.

Example 3 includes the vehicle of any preceding example, wherein the angle overlay limit is proportional to the driver activity and inversely proportional to vehicle speed.

Example 4 includes the vehicle of any preceding example, wherein the angle overlay limit is a rate limit.

Example 5 includes the vehicle of any preceding example, wherein the rate limit is a non-zero value and the controller is further to determine a rate of change of the angle overlay, and after determining the rate of change of the angle overlay exceeds the rate limit, deactivate the driver-assistance system.

Example 6 includes the vehicle of any preceding example, wherein the controller is further to determine a magnitude of the angle overlay, the magnitude having a first direction, and after determining the magnitude exceeds a magnitude limit, set the rate limit to approximately zero in the first direction.

Example 7 includes the vehicle of any preceding example, wherein the angle overlay limit is a magnitude limit.

Example 8 includes a non-transitory computer readable medium comprising instructions, which, when executed cause a processor to determine an angle overlay based on an input to a user interface, determine an angle overlay limit based on a driver activity and a speed of a vehicle, modify the angle overlay based on the angle overlay limit to generate a modified angle overlay, determine a second reference navigation angle based on the modified angle overlay and a first reference navigation angle of a driver-assistance system, and control the vehicle based on the second reference navigation angle.

Example 9 includes the non-transitory computer readable medium of any preceding example, wherein the user interface is a steering wheel and the instructions, when executed, cause the processor to determine the driver activity based on a torque applied to the steering wheel.

Example 10 includes the non-transitory computer readable medium of any preceding example, wherein the angle overlay limit is proportional to the driver activity and inversely proportional to vehicle speed.

Example 11 includes the non-transitory computer readable medium of any preceding example, wherein the angle overlay limit is a rate limit.

Example 12 includes the non-transitory computer readable medium of any preceding example, the instructions, when executed, cause the processor to determine a magnitude of the angle overlay, the magnitude having a first direction, and after determining the magnitude exceeds a magnitude limit, set the rate limit to approximately zero in the first direction.

Example 13 includes the non-transitory computer readable medium of any preceding example, wherein the angle overlay limit is a magnitude limit.

Example 14 includes the non-transitory computer readable medium of any preceding example, wherein the instructions, when executed, cause the processor to determine a magnitude of the angle overlay, and after determining the magnitude of the angle overlay exceeds the magnitude limit, deactivate the driver-assistance system.

Example 15 includes a method comprising determining an angle overlay based on an input to a user interface, determining an angle overlay limit based on a driver activity and a speed of a vehicle, modifying the angle overlay based on the angle overlay limit to generate a modified angle overlay, determining a second reference navigation angle based on the modified angle overlay and a first reference navigation angle of a driver-assistance system, and controlling the vehicle based on the second reference navigation angle.

Example 16 includes the method of any preceding example, wherein the user interface is a steering wheel and the method further includes determining the driver activity based on a torque applied to the steering wheel.

Example 17 includes the method of any preceding example, wherein the angle overlay limit is proportional to the driver activity and inversely proportional to vehicle speed.

Example 18 includes the method of any preceding example, wherein the angle overlay limit is a rate limit.

Example 19 includes the method of any preceding example, wherein the rate limit is a non-zero value, and the method further includes determining a rate of change of the angle overlay, and after determining the rate of change of the angle overlay exceeds the rate limit, deactivating the driver-assistance system.

Example 20 includes the method of any preceding example, further including determining a magnitude of the angle overlay, the magnitude having a first direction, and after determining the magnitude exceeds a magnitude limit, setting the rate limit to approximately zero in the first direction.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle including:
a user interface;
a driver-assistance system to generate a first reference navigation angle; and
a controller to:
determine an angle overlay based on an input to the user interface;
determine an angle overlay limit based on a driver activity and a speed of the vehicle;
modify the angle overlay based on the angle overlay limit to generate a modified angle overlay;
determine a second reference navigation angle based on the modified angle overlay and the first reference navigation angle; and
control the vehicle based on the second reference navigation angle.

2. The vehicle of claim 1, wherein the user interface is a steering wheel and the controller is further to determine the driver activity based on a torque applied to the steering wheel.

3. The vehicle of claim 1, wherein the angle overlay limit is proportional to the driver activity and inversely proportional to vehicle speed.

4. The vehicle of claim 1, wherein the angle overlay limit is a rate limit.

5. The vehicle of claim 4, wherein the rate limit is a non-zero value and the controller is further to:
determine a rate of change of the angle overlay; and
after determining the rate of change of the angle overlay exceeds the rate limit, deactivate the driver-assistance system.

6. The vehicle of claim 4, wherein the controller is further to:
determine a magnitude of the angle overlay, the magnitude having a first direction; and
after determining the magnitude exceeds a magnitude limit, set the rate limit to approximately zero in the first direction.

7. The vehicle of claim 1, wherein the angle overlay limit is a magnitude limit.

8. A non-transitory computer readable medium comprising instructions, which, when executed cause a processor to:
determine an angle overlay based on an input to a user interface;
determine an angle overlay limit based on a driver activity and a speed of a vehicle;
modify the angle overlay based on the angle overlay limit to generate a modified angle overlay;
determine a second reference navigation angle based on the modified angle overlay and a first reference navigation angle of a driver-assistance system; and
control the vehicle based on the second reference navigation angle.

9. The non-transitory computer readable medium of claim 8, wherein the user interface is a steering wheel and the instructions, when executed, cause the processor to determine the driver activity based on a torque applied to the steering wheel.

10. The non-transitory computer readable medium of claim 8, wherein the angle overlay limit is proportional to the driver activity and inversely proportional to vehicle speed.

11. The non-transitory computer readable medium of claim 8, wherein the angle overlay limit is a rate limit.

12. The non-transitory computer readable medium of claim 11, the instructions, when executed, cause the processor to:
determine a magnitude of the angle overlay, the magnitude having a first direction; and
after determining the magnitude exceeds a magnitude limit, set the rate limit to approximately zero in the first direction.

13. The non-transitory computer readable medium of claim 8, wherein the angle overlay limit is a magnitude limit.

14. The non-transitory computer readable medium of claim 13, wherein the instructions, when executed, cause the processor to:
determine a magnitude of the angle overlay; and
after determining the magnitude of the angle overlay exceeds the magnitude limit, deactivate the driver-assistance system.

15. A method comprising:
determining an angle overlay based on an input to a user interface;
determining an angle overlay limit based on a driver activity and a speed of a vehicle;
modifying the angle overlay based on the angle overlay limit to generate a modified angle overlay;
determining a second reference navigation angle based on the modified angle overlay and a first reference navigation angle of a driver-assistance system; and
controlling the vehicle based on the second reference navigation angle.

16. The method of claim 15, wherein the user interface is a steering wheel and the method further includes determining the driver activity based on a torque applied to the steering wheel.

17. The method of claim 15, wherein the angle overlay limit is proportional to the driver activity and inversely proportional to vehicle speed.

18. The method of claim 15, wherein the angle overlay limit is a rate limit.

19. The method of claim 18, wherein the rate limit is a non-zero value, and the method further includes:
determining a rate of change of the angle overlay; and
after determining the rate of change of the angle overlay exceeds the rate limit, deactivating the driver-assistance system.

20. The method of claim 18, further including:
determining a magnitude of the angle overlay, the magnitude having a first direction; and
after determining the magnitude exceeds a magnitude limit, setting the rate limit to approximately zero in the first direction.
